(19) United States
(12) Patent Application Publication
(10) Pub. No.: US 2002/0113388 A1
(43) Pub. Date: Aug. 22, 2002

(54) Wheelbarrow

(76) Inventor: Graham Robinson, Stoke On Trent (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/079,474

(22) Filed: Feb. 19, 2002

(30) Foreign Application Priority Data
Feb. 17, 2001 (GB) 0103947.8
Jun. 21, 2001 (GB) 0115127.3
Aug. 20, 2001 (GB) 0120210.0
Sep. 14, 2001 (GB) 0122193.6
Oct. 12, 2001 (GB) 0124533.1

(51) Int. Cl. B62B 1/18

(52) U.S. Cl. 280/47.31

(57) ABSTRACT

A wheelbarrow is described comprising a frame, a body for receipt of a load and a wheel, where in use the body is mounted on the frame and the wheel is rotatably mounted on the frame by means of an axle towards a front thereof and wherein the wheel is demountable from the frame without the use of tools. The axle is substantially cylindrical with a head at one end and a retaining formation at or adjacent the second end for co-operation with an axle retaining clip. In some embodiments the body is detachably secured to the main frame in a manner which is readily detachable without the use of tools, and in other embodiments the body is permanently secured to the main frame.

### CROSS-REFERENCE TO RELATED APPLICATIONS

Priority is claimed to United Kingdom patent applications Serial Nos. 0103947.8 filed Feb. 17, 2001, 0115127.3 filed Jun. 21, 2001, 0120210.0 filed Aug. 20, 2001, 0122193.6 filed Sept. 14, 2001 and 0124533.1 filed Oct. 12,2001.

### STATEMENT REGARDING FEDERALLY SPONSORED RESEARCH OR DEVELOPMENT

Not Applicable.

### TECHNICAL FIELD

The invention relates to a wheelbarrow of the general kind used on building sites and in domestic gardens, which can be at least partially disassembled without the use of tools.

### BACKGROUND OF THE INVENTION

Conventional wheelbarrows comprise a frame, a body or container for receipt of a load, and a wheel rotatably mounted on the frame by means of an axle. In the prior art, the body is secured to the frame by means of a threaded fastener, such as screws or nuts and bolts, and the axle is also held in place with nuts. Hence to demount the body from the frame or the wheel from the frame requires the use of tools.

There are a number of problems associated with such prior art wheelbarrows. One is that wheelbarrows are generally supplied already assembled, due to a reluctance on the part of the user to undertake assembly requiring tools. This has significant disadvantages in terms of storage and transport as assembled wheelbarrows do not stack well. When a wheelbarrow is sold in a form which requires assembly by the purchaser, tools and some degree of skill are required for the purchaser to properly assembly the wheelbarrow. Another disadvantage is that users tend not to repair wheelbarrows when either bodies break or the wheels suffer damage because of the added problems of disassembling the damaged part.

Many attempts have been made over the years to provide wheelbarrows in which one or more parts can be readily disassembled for whatever reason. However, most of these less conventional wheelbarrows appear not to have found favor with the public and do not appear to be commercially available. Examples of wheelbarrows from which the bodies can be readily disassembled are described in U.S. Pat. No. 6,328,331, and British patents GB 2,220,391 A and GB 2,331,048 A. An example of a readily releasable wheel for a wheelbarrow is shown in U.S. Pat. 6,095,535, whilst an example of wheel for various uses, e.g. perambulators and toys, and which is releasable is described in European patent application EP 0,083,451 A1. None of these prior art documents provide the feature of disassembly in very simple ways, and this is particularly the case with the releasable wheels.

It is an object of the present invention to provide a wheelbarrow which mitigates one or more of the above described problems.

### BRIEF SUMMARY OF THE INVENTION

According to a first aspect of the present invention there is provided a wheelbarrow comprising a frame, a body or container for receipt of a load and a wheel. In use the body is mounted on the frame, and the wheel is rotatably mounted on the frame by means of an axle towards a front thereof, and wherein the wheel is demountable from the frame without the use of tools, the axle is substantially cylindrical with a head at one end and a retaining formation at or adjacent the other end for co-operation with an axle retaining clip. This provides the advantage that the wheel can readily be demounted for repair or replacement, or for storage or transport.

Preferably, the retaining formation includes a hole through the axle adjacent the second end substantially perpendicular to it's length and the axle retaining clip is received in the hole in the axle to retain the axle and wheel in their use positions mounted relative to the frame. The axle retaining clip may comprise an R-spring clip. Preferably the axle retaining clip further includes a finger loop for ease of removal.

Preferably, the body is demountable from the frame without the use of tools. The body may be mounted on the frame by means of pins with retaining elements, and co-operating retaining clips, the pins being inserted through aligned holes provided on the bottom of the body and the frame, and the retaining clips being attached to retain the pins in place. Preferably, each pin is substantially cylindrical with a head at one end and a hole through adjacent the other end and the retaining clips are R-spring clips. Alternatively the body may be permanently secured to the frame, for example by welding.

According to a second aspect of the invention a wheelbarrow comprises a frame, a body for receipt of a load and a wheel, where in use the body is mounted on the frame and the wheel is rotatably mounted on the frame by means of an axle towards the front thereof and wherein the wheelbarrow is demountable into the three components of frame, body and wheel without the use of tools.

Various objects and advantages of the invention will become apparent from the following detailed description of the invention and the accompanying drawings.

### BRIEF DESCRIPTION OF THE DRAWINGS

FIG. 1 is a side elevational view of a wheelbarrow according to the invention;

FIG. 2 is a bottom plan view of the wheelbarrow of FIG. 1;

FIG. 3 is an exploded view of the front of the wheelbarrow of FIG. 1 showing the manner in which the wheel is detachably secured;

FIG. 4 is a fragmentary exploded view showing the manner in which the front of the body of the wheelbarrow is detachably secured to the main frame; and

FIG. 5 is an exploded view showing the manner in which the rear of the body of the wheelbarrow is detachably secured to the main frame.

### DETAILED DESCRIPTION OF THE INVENTION

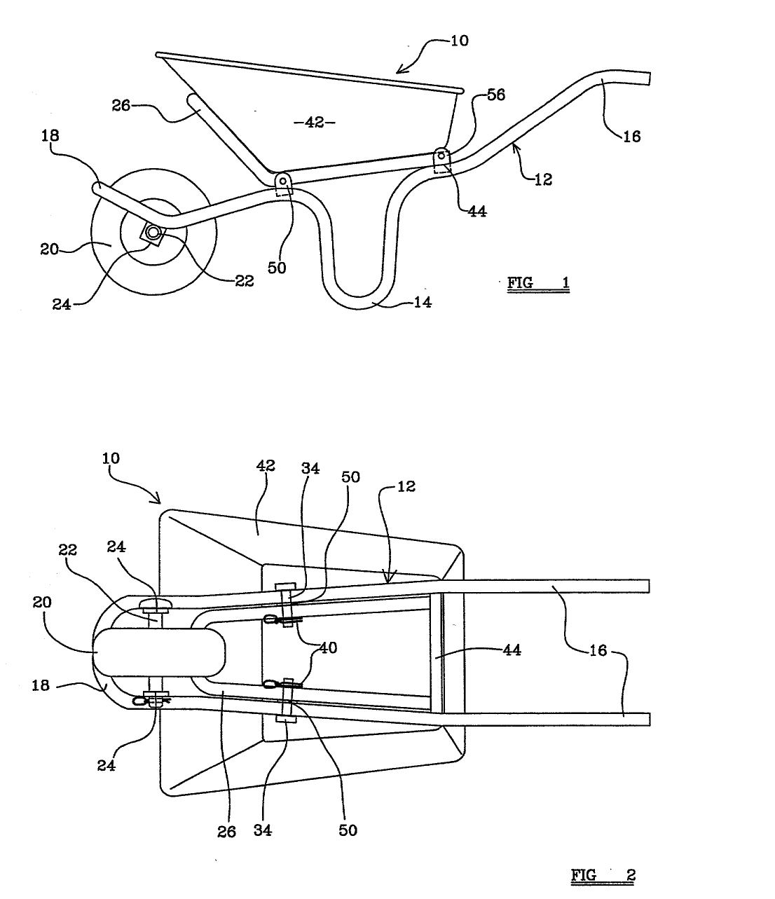

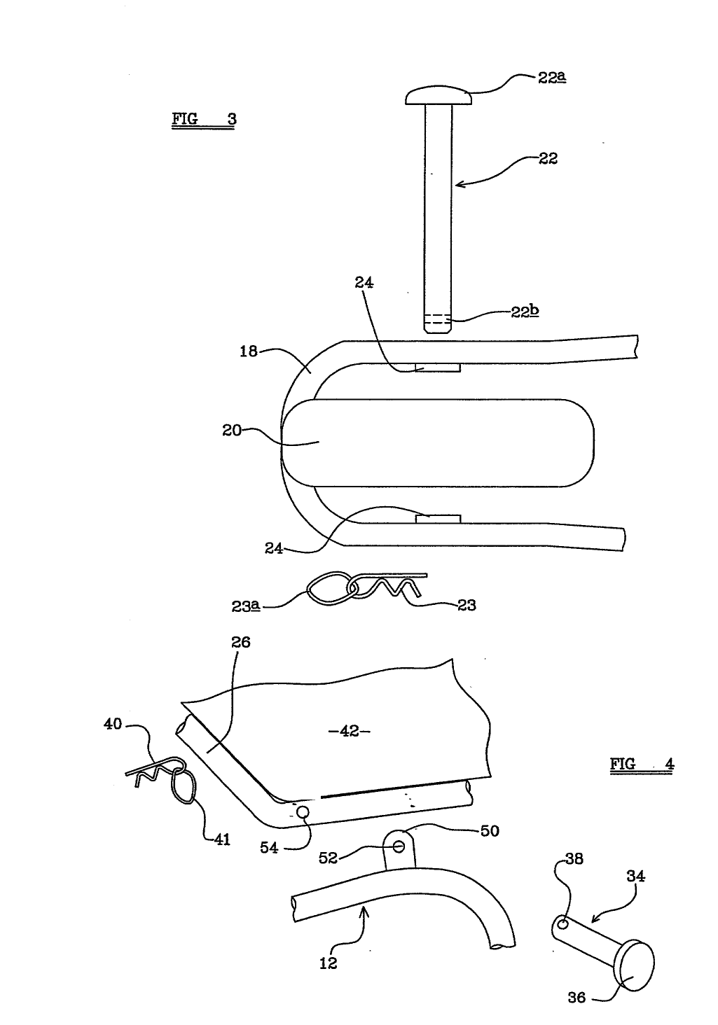

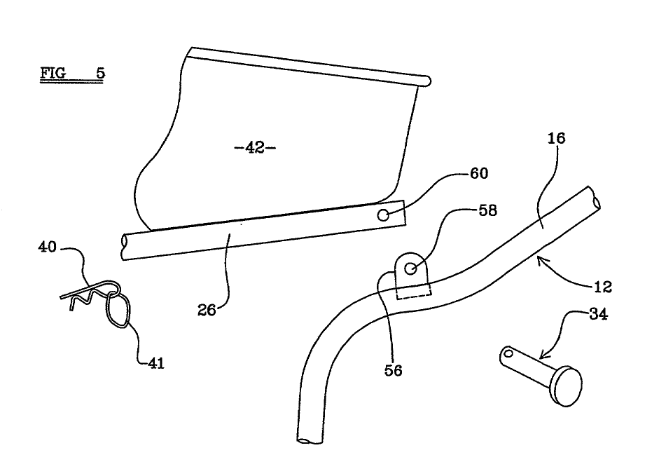

Referring to FIGS. 1 to 4, a wheelbarrow 10 according to the invention comprises a main frame 12, which provides support means in the form of a pair of ground engaging support portions 14, a pair of rearwardly extending handles 16, and a U-shaped portion 18 at the front thereof. The pair of ground engaging support portions 14 of the main frame 12 take the form of downwardly extending U-shaped portions of the main frame 12. The main frame 12 may be in the form of a single tube bent to form the main frame 12, as shown, or it may be of other known configurations, such as a frame formed from components welded or bolted together as is known in the art.

A single wheel 20 is pivotally mounted, by means of an axle 22, on the main frame 12 towards a front end thereof. The axle 22 is supported below the main frame 12 by means of a pair of brackets 24 secured to the main frame 12. The axle 22 is substantially cylindrical with a head 22a at one end and a retaining formation in the form of a hole 22b through adjacent the other end and perpendicular to it's length. The axle 22 is retained in place through the brackets 24 and the wheel 20 by means of a retaining clip 23, in the form of an R-spring clip. Preferably, the clip 23 is provided with a finger loop 23a for ease of removal. The wheel 20 can thus be readily detached from the wheelbarrow 10 for example, for replacement or repair if damaged, or for ease of storage or transport.

The wheelbarrow 10 further comprises a sub frame 26 which is removably or detachably secured to the main frame 12 as will be described later.

The wheelbarrow 10 further includes a body or container 42 for carrying a load secured to the sub frame 26, by any appropriate means such as welding or with bolts, and a cross member 44 secured between the two sides of the main frame 12 just rearwardly of the ground engaging support portions 14, and forwardly of the handles 16. The cross member 44 supports the rear of the sub frame 26.

A bracket 50, bearing a hole 52, is secured to each side of the main frame 12 forwardly of the ground engaging support portions 14 and extending upwardly therefrom, on the inner side of the main frame 12. A hole 54 is provided on each side of the sub frame 26. The holes 54 align with the holes 52 when the sub frame 26 and body 42 are in appropriate relationship to the main frame 12. Pins 34 are inserted through the aligned holes 52 and 54 and secured there by means of retaining clips 40, preferably in the form of R-spring clips which are provided with finger loops 41 for ease of removal of the clips 40. Thus the front portion of the body 42 is detachably secured to the main frame 12.

A further bracket 56, bearing a hole 58, is also provided on each side of the main frame 12 rearwardly of the ground engaging portions 14, and extending upwardly therefrom, on the inner side of the main frame 12. A hole 60 is provided on each side of the sub frame 26. The holes 60 align with holes 58 when the sub frame 26 and body 42 are in appropriate relationship to the main frame 12. Further pins 34 are inserted through the aligned holes 58 and 60 and secured there by means of retaining clips 40, again preferably in the form of R-spring clips 40. Thus the rear portion of the body 42 is detachably secured to the main frame 12.

The wheelbarrow 10 has the advantage that the three main components, that is, the main frame 12, the body 42 and the wheel 20, can be mounted to each other to form the working wheelbarrow 10, and can be easily demounted, without the use of tools. Thus if one of the three components fails it can readily be replaced. Furthermore the wheelbarrow 10 can be quickly disassembled for ease of storage or transport.

In an alternative embodiment the body 42, with or without a sub frame 26, may be permanently secured to the main frame 12 by appropriate means with regard to the materials of the components concerned. For example if the components are all steel as in many wheelbarrows, they may be welded together. In some circumstances adhesives may also be used.

Although all the retaining clips used in the embodiments are described as being R-spring clips, it will be appreciated that any other appropriate form of clip for receipt in the hole in the axle 22 or the pins 34 may be used.

It will also be apparent that other forms of axle may be used to implement the invention, particularly with different forms of retaining means rather than a hole through adjacent the end opposite to the head. For example the retaining means could comprise an indentation running around the axle adjacent the second end, and the retaining clip could comprise some form of C- shaped clip received in the indentation.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A wheelbarrow comprising a frame, a body for receipt of a load and a wheel, an axle rotatably mounting said wheel on said frame, said axle having an elongated cylindrical portion terminating at a head at a first end and at a retaining formation adjacent a second end, said frame including a pair of aligned wheel mounting holes spaced apart for receiving said wheel therebetween, said wheel mounting holes having a diameter for receiving said cylindrical portion and smaller than said head, an axle retaining clip adapted to releasably engage said retaining formation on said axle and wherein no tools are needed to disengage said axle retaining clip from said axle, whereby said wheel is detachably mounted on said frame by passing said second axle end through a first of said wheel mounting holes, through an axle opining in said wheel and through the second of said wheel mounting holes and attaching said axle retaining clip to said retaining formation.

2. A wheelbarrow according to claim 1, and wherein said wheel mounting holes are on brackets secured to said frame.

3. A wheelbarrow according to claim 1, and wherein said retaining formation includes a hole through said axle adjacent said second end substantially perpendicular to said elongated cylindrical portion and wherein said axle retaining clip is received in said hole in said axle to retain said axle and said wheel in their use positions mounted relative to said frame.

4. A wheelbarrow according to claim 3, and wherein said axle retaining clip is an R-spring clip.

5. A wheelbarrow according to claim 3, wherein said axle retaining clip further includes a finger loop for ease of removal.

6. A wheelbarrow according to claim 1, and wherein said body is permanently secured to said frame.

7. A wheelbarrow according to claim 6, and wherein the body is permanently secured to said frame by welding.

8. A wheelbarrow according to claim 1, wherein said body is detached from said frame without the use of tools.

9. A wheelbarrow according to claim 8, and wherein said body is mounted on the frame by means of a plurality of pins having retaining formations, and co-operating body retaining clips, said pins passing through aligned body mounting holes provided on the bottom of said body and on said frame when said body is aligned with said frame, and said body retaining clips releasably engaging said pins to retain the pins in said aligned holes.

10. A wheelbarrow according to claim 9, and wherein each of said pins is substantially cylindrical with a head at one end and a through hole adjacent a second end and wherein said body retaining clips are R-spring clips adapted to releasably engage said through holes in said pins.

11. A wheelbarrow according to claim 9, and wherein said body mounting holes on the bottom of said body are on a sub frame secured to the bottom of said body.

12. A wheelbarrow according to claim 11, and wherein said body mounting holes on said frame are on brackets secured to said frame.

13. A wheelbarrow comprising a frame, a body for receipt of a load and a wheel, where in use said body is mounted on said frame and said wheel is rotatably mounted on said frame by means of an axle towards a front thereof, and wherein said frame, said body and said wheel can be disassembled into the three components without the use of tools.
